(19) United States
(12) Patent Application Publication
(10) Pub. No.: US 2024/0428572 A1
(43) Pub. Date: Dec. 26, 2024

(54) PROGRAM, INFORMATION PROCESSING APPARATUS, AND INFORMATION PROCESSING METHOD

(71) Applicant: Sony Group Corporation, Tokyo (JP)

(72) Inventors: Kohei UMEKI, Kanagawa (JP); Hidetoshi NAGANO, Saitama (JP)

(73) Assignee: Sony Group Corporation, Tokyo (JP)

(21) Appl. No.: 18/684,189

(22) PCT Filed: Mar. 22, 2022
(86) PCT No.: PCT/JP2022/013178

§ 371 Date: Feb. 16, 2024

(30) Foreign Application Priority Data
Sep. 2, 2021 (JP) 2021-143413

(51) Int. Cl. G06V 10/776; G06T 11/00; G06V 10/25; G06V 10/764

(52) U.S. Cl. CPC G06V 10/776; G06T 11/00; G06V 10/25; G06V 10/764

(57) ABSTRACT

A program causes an arithmetic processing device to execute a validity evaluation function of evaluating validity of a gaze region on the basis of a prediction region that is an image region in which a recognition target is predicted to exist by image recognition using artificial intelligence on an input image and the gaze region that is an image region that is a basis of prediction.

### TECHNICAL FIELD

The present technology relates to a technical field of a program, an information processing apparatus, and an information processing method for performing processing of determining that a basis of a prediction result of image recognition using artificial intelligence is valid.

### BACKGROUND ART

There is a technology for detecting and classifying a subject by performing image recognition using artificial intelligence (AI).

In the performance evaluation of the AI model used for such artificial intelligence, it is important to consider not only the correctness of the prediction result but also whether or not the basis for deriving the prediction result is valid.

There is a technology for visualizing the basis of a prediction result of image recognition by artificial intelligence (for example, Patent Document 1).

### CITATION LIST

### Patent Document

Patent Document 1: Japanese Patent Application Laid-Open No. 2021-093004

### SUMMARY OF THE INVENTION

### Problems to be Solved by the Invention

However, the number of images used for learning the AI model is enormous, and it is difficult to confirm validity of the basis of the prediction results for all the images.

The present technology has been made in view of such a problem, and an object thereof is to reduce the cost required for confirming the basis that the prediction result of image recognition using artificial intelligence has been derived.

### Solutions to Problems

A program according to the present technology causes an arithmetic processing device to execute a validity evaluation function of evaluating validity of a gaze region on the basis of a prediction region that is an image region in which a recognition target is predicted to exist by image recognition using artificial intelligence on an input image and the gaze region that is an image region that is a basis of prediction.

For example, both determination of whether or not the gaze region is valid, determination of only that the gaze region is valid, determination of only that the gaze region is invalid, and the like are performed.

An information processing apparatus according to the present technology includes a validity evaluation unit that evaluates validity of a gaze region on the basis of a prediction region that is an image region in which a recognition target is predicted to exist by image recognition using artificial intelligence on an input image and the gaze region that is an image region that is a basis of prediction.

In an information processing method according to the present technology, an arithmetic processing device executes validity evaluation processing of evaluating validity of a gaze region on the basis of a prediction region that is an image region in which a recognition target is predicted to exist by image recognition using artificial intelligence on an input image and the gaze region that is an image region that is a basis of prediction.

The above-described effects can also be obtained by such an information processing apparatus or information processing method.

### BRIEF DESCRIPTION OF DRAWINGS

FIG. 1 is a functional block diagram of an information processing apparatus according to the present technology.

FIG. 2 is a diagram illustrating an example of an input image.

FIG. 3 is a diagram illustrating an example of a prediction region and a gaze region.

FIG. 4 is a functional block diagram of a gaze region specification unit.

FIG. 5 is a diagram illustrating an example of a state in which an input image is divided into partial image regions.

FIG. 6 is a diagram illustrating an example of a mask image.

FIG. 7 is a first example of visualized contribution degree.

FIG. 8 is a second example of visualized contribution degree.

FIG. 9 is a third example of visualized contribution degree.

FIG. 10 is a diagram illustrating an example in which two gaze regions are specified for one prediction region.

FIG. 11 is a functional block diagram of a classification unit.

FIG. 12 is a diagram illustrating an example of a classification result.

FIG. 13 is a diagram illustrating a first example of a presentation screen.

FIG. 14 is a diagram illustrating a second example of presentation screen.

FIG. 15 is a diagram illustrating a third example of presentation screen.

FIG. 16 is a diagram illustrating a fourth example of presentation screen.

FIG. 17 is a diagram illustrating a fifth example of presentation screen.

FIG. 18 is a block diagram of a computer device.

FIG. 19 is a flowchart illustrating an example of processing executed by the information processing apparatus until the evaluation result of the validity of the gaze region is presented to the user.

FIG. 20 is a flowchart illustrating an example of contribution degree visualization processing.

FIG. 21 is a flowchart illustrating an example of classification processing.

FIG. 22 is a flowchart illustrating another example of classification processing.

FIG. 23 is a flowchart illustrating processing executed by each information processing apparatus until the AI model for the user to achieve the purpose is created.

FIG. 24 is a flowchart illustrating processing executed by each information processing apparatus in a case where erroneous recognition occurs in the created AI model.

### MODE FOR CARRYING OUT THE INVENTION

Hereinafter, embodiments according to the present technology will be described in the following order with reference to the accompanying drawings.
<1. Configuration of Information Processing Apparatus>
<2. Computer Device>
<3. Processing Flow>
<4. Application Example>
<5. Summary>
<6. Present Technology>

### 1. Configuration of Information Processing Apparatus

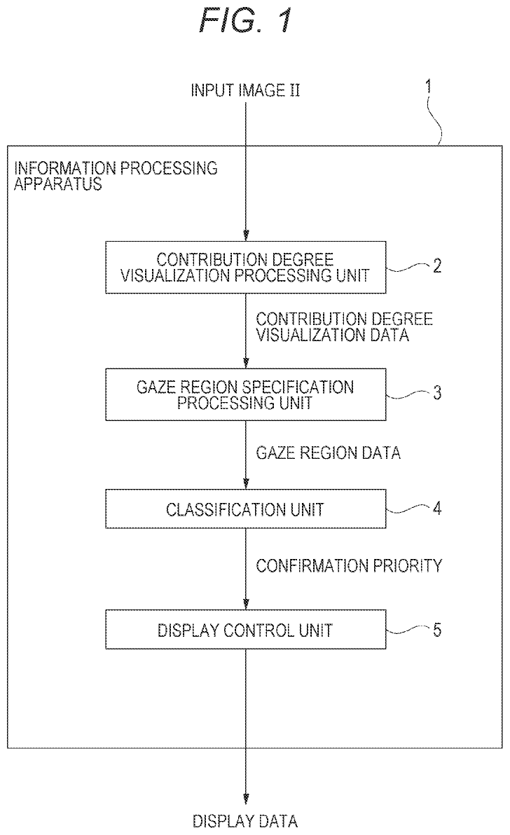

A functional configuration of an information processing apparatus 1 in the present embodiment will be described with reference to FIG. 1.

The information processing apparatus 1 is an apparatus that performs various processes according to an instruction of a user (worker) who confirms validity of a processing result of image recognition using artificial intelligence (AI).

The information processing apparatus 1 may be, for example, a computer device as a user terminal used by a user or a computer device as a server device connected to the user terminal.

The information processing apparatus 1 uses the processing result of image recognition as input data, and outputs information that the user wants to confirm from among the input data.

The information processing apparatus 1 includes a contribution degree visualization processing unit 2, a gaze region specification processing unit 3, a classification unit 4, and a display control unit 5.

The contribution degree visualization processing unit 2 performs a process of calculating and visualizing the contribution degree DoC for each region for the prediction region FA in which the recognition target RO is predicted to exist in the input image II. The calculated contribution degree DoC is used to specify the gaze region GA in the subsequent stage.

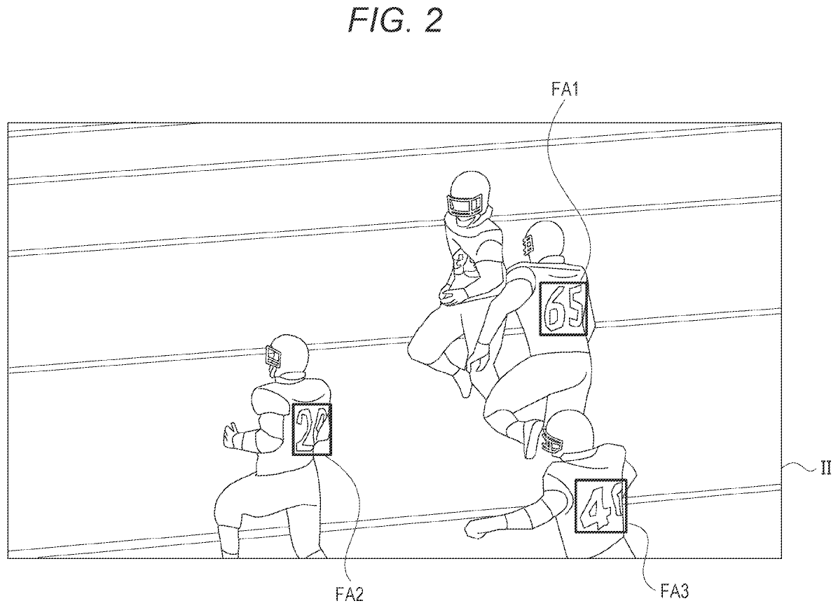

Here, the input image II, the prediction region FA, and the gaze region GA will be described. FIG. 2 is an example of an input image II obtained by imaging an American football player. As illustrated, the input image II includes four players.

In a case where the recognition target RO is set to “uniform number”, the prediction regions FA1, FA2, and FA3 are extracted by the image recognition processing using the AI model. That is, each of the prediction regions FA1, FA2, and FA3 is a region estimated by the AI as having a high possibility of including a uniform number.

Each prediction region FA is determined to have a high possibility of including a uniform number based on different regions. A region that is a basis of the prediction with respect to the prediction region FA is set as the gaze region GA.

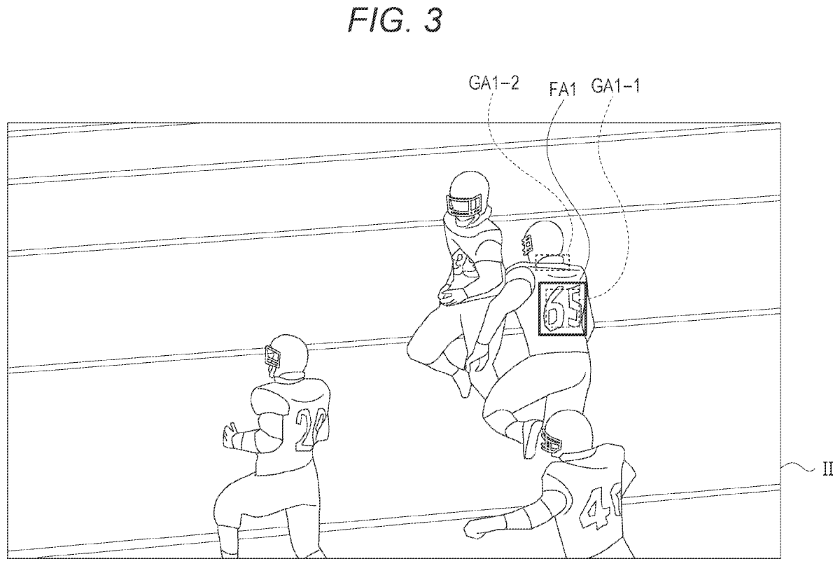

FIG. 3 illustrates gaze region GA1 for prediction region FA1. Note that a plurality of gaze regions GA may exist for one prediction region FA. Furthermore, the gaze region GA may not be rectangular.

For example, in the example illustrated in FIG. 3, two gaze regions GA1-1 and GA1-2 exist for the prediction region FA1.

That is, in the AI model, the position of the back is specified in consideration of not only the portion of the number of the uniform number but also the portion of the neck of the player, and it is estimated that the number is the uniform number, thereby recognizing the uniform number as the recognition target RO.

The contribution degree visualization processing unit 2 calculates the contribution degree DoC for each prediction region FA on the input image II. In the following description, processing of calculating the contribution degree DoC for the prediction region FA1 will be described.

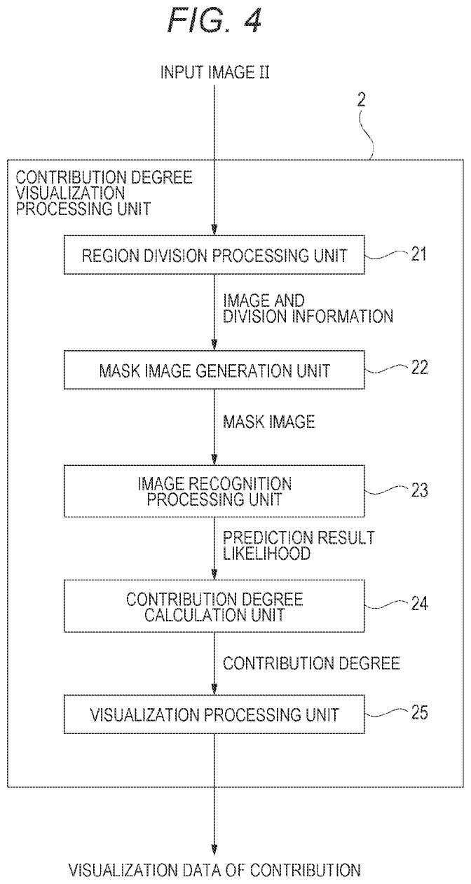

FIG. 4 illustrates a detailed functional configuration of the contribution degree visualization processing unit 2.

The contribution degree visualization processing unit 2 includes a region division processing unit 21, a mask image generation unit 22, an image recognition processing unit 23, a contribution degree calculation unit 24, and a visualization processing unit 25.

The region division processing unit 21 divides the input image II into a plurality of partial image regions DI. As a division method, for example, a superpixel or the like may be used.

In the present embodiment, the region division processing unit 21 divides the input image II into a matrix such that rectangular partial image regions DI are arranged in a matrix.

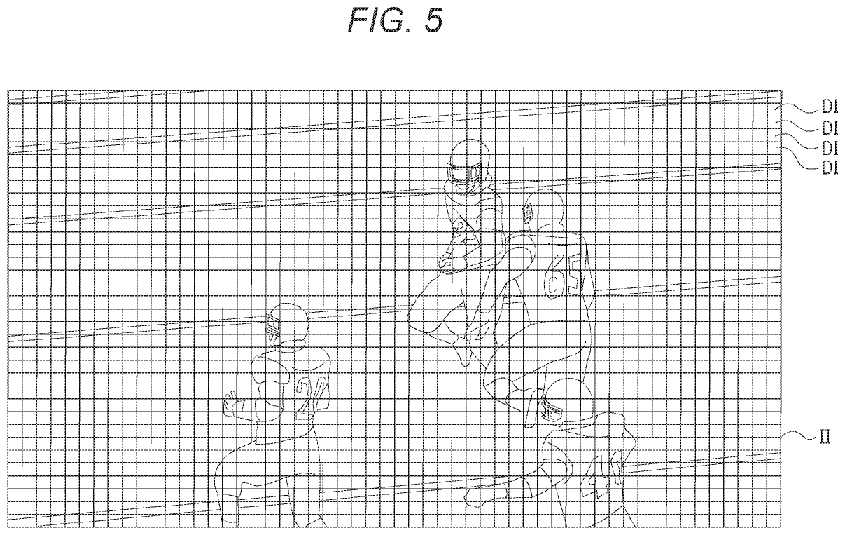

An example of the input image II and the partial image region DI is illustrated in FIG. 5. As illustrated, the input image II is divided into a large number of partial image regions DI.

The mask image generation unit 22 generates a mask image MI by applying a mask pattern for masking a part of the partial image region DI to the input image II.

The mask pattern is created by determining whether or not to mask each of the M partial image regions DI included in the input image II.

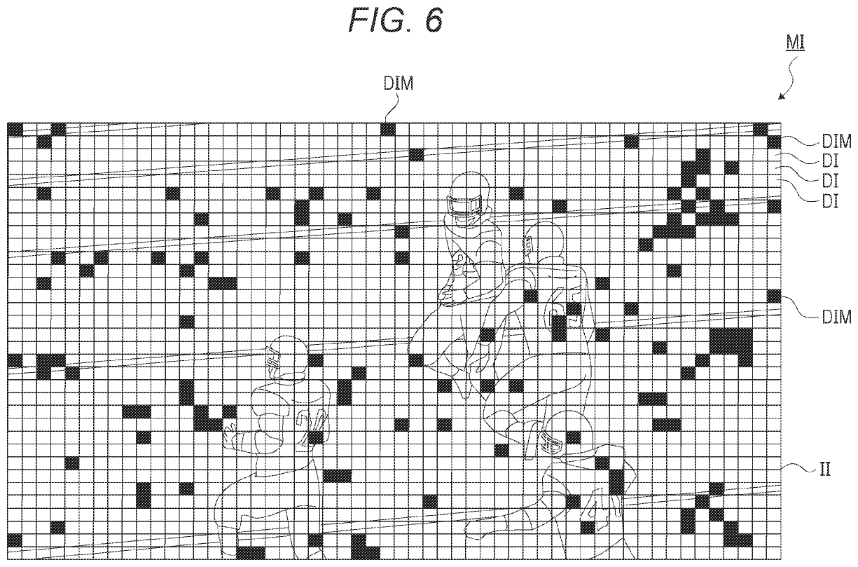

FIG. 6 illustrates an example of a mask image MI in which one of the created mask patterns is applied to the input image II. The masked partial image region DI is set as a partial image region DIM.

Assuming that the number of partial image regions DI is M, there are 2 M-th power type mask images MI.

If the number of mask images MI used for calculating the contribution degree DoC is too large, the calculation amount excessively increases, and thus, the mask image generation unit 22 generates, for example, several hundred to tens of thousands of types of mask images MI.

The image recognition processing unit 23 performs image recognition processing using the AI model with the mask image MI generated by the mask image generation unit 22 as input data.

Specifically, the prediction result likelihood PLF (inference score) for the prediction region FA1 is calculated for each mask image MI.

The prediction result likelihood PLF is information indicating the certainty of the estimation result that the recognition target RO (for example, a uniform number) is included in the prediction region FA1 to be processed, that is, the correctness of inference.

For example, in a case where the partial image region DI important in prediction is masked, the prediction result likelihood PLF becomes small.

On the other hand, in a case where the partial image region DI important in prediction is not masked, the prediction result likelihood PLF increases.

Furthermore, for the partial image region DI important in prediction, the difference between the prediction result likelihood PLF in the case of being masked and the prediction result likelihood PLF in the case of not being masked is large. Then, for the partial image region DI that is not important in prediction, the difference between the prediction result likelihood PLF in the case of being masked and the prediction result likelihood PLF in the case of not being masked is small.

In other words, it is possible to calculate a difference in the prediction result likelihood PLF between the case of being masked and the case of not being masked for each partial image region DI and estimate that the greater the difference, the higher the importance of the partial image region DI in prediction.

The image recognition processing unit 23 calculates the prediction result likelihood PLF for each prepared mask image MI.

The contribution degree calculation unit 24 calculates the contribution degree DoC for each partial image region DI using the prediction result likelihood PLF for each mask image MI.

The contribution degree DoC is information indicating a degree of contribution to the detection of the recognition target RO. That is, the partial image region DI having a high contribution degree DoC is a region having a high degree of contribution to the detection of the recognition target RO.

For example, in a case where a certain partial image region DI is masked, the prediction result likelihood PLF becomes low, and in a case where a certain partial image region DI is not masked, the prediction result likelihood PLF becomes high, and the contribution degree DoC of the partial image region DI becomes high.

An example of a method of calculating the contribution degree DoC will be described.

The input image II is divided into M partial image regions DI, which are partial image regions DI1, DI2, . . . , DIM, respectively.

The prediction result likelihood PLF of the result of performing the image recognition processing on the mask image MI1 is set as the prediction result likelihood PLF1.

The contribution degree DoC of each of the partial image regions DI1, DI2, . . . DIM is defined as the contribution degrees DoC1, DoC2, . . . DoCM.

At this time, the following Expression (1) is obtained for the prediction result likelihood PLF1.

$$PLF 1 = A 1 \times DoC 1 + A 2 \times DoC 2 + … + AM \times DoCM \qquad Expression ( 1 )$$

Here, A1, A2, . . . AM are coefficients for each partial image region DI, and are set to “0” in the case of being masked and set to “1” in the case of not being masked.

For example, in a case where 1000 types of mask images MI 1 to MI 1000 are used, it is possible to obtain 1000 expressions in which the patterns of the coefficients A1 to AM of the left side and the right side of Expression (1) are different.

By using a large number of Expressions (1), it is possible to obtain an optimal solution of the contribution degree DoC1 to DoCM. That is, the accuracy of the calculated contribution degree DoC increases as the number of mask images MI to be prepared increases.

Note that, since the partial image region DI is divided into regions in a lattice shape, it is possible to divide a portion that has been one region in the superpixel into a plurality of regions, and thus, it is possible to more finely analyze a region having a high contribution degree DoC.

The visualization processing unit 25 performs a process of visualizing the contribution degree DoC. Several visualization methods are conceivable.

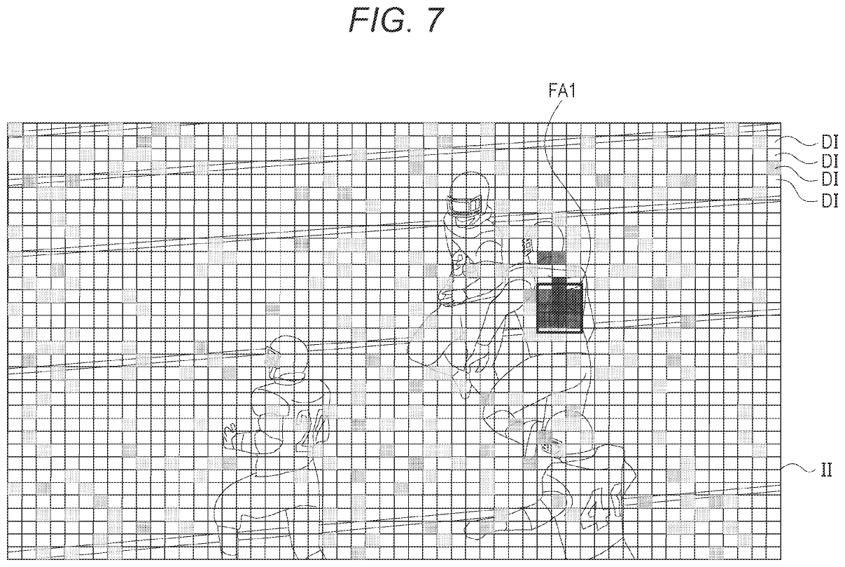

FIG. 7 illustrates a first example of the visualized contribution degree DoC. In this example, the height of the contribution degree DoC is indicated by the shade of the filled color. That is, the partial image region DI having a higher contribution degree DoC is filled with a darker color.

As illustrated, it can be seen that the contribution degree DoC of the partial image region DI included in the prediction region FA1 and the partial image region DI around the neck of the player is high.

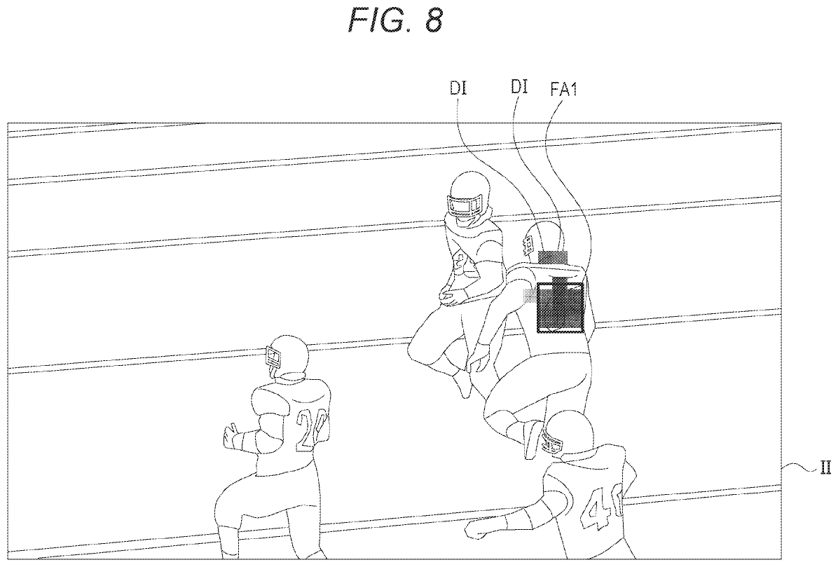

FIG. 8 illustrates a second example of the visualized contribution degree DoC. In this example, only the partial image region DI in which the contribution degree DoC is equal to or greater than a certain value is filled and displayed. The color density of the fill of the contribution degree DoC is proportional to the height of the contribution degree DoC.

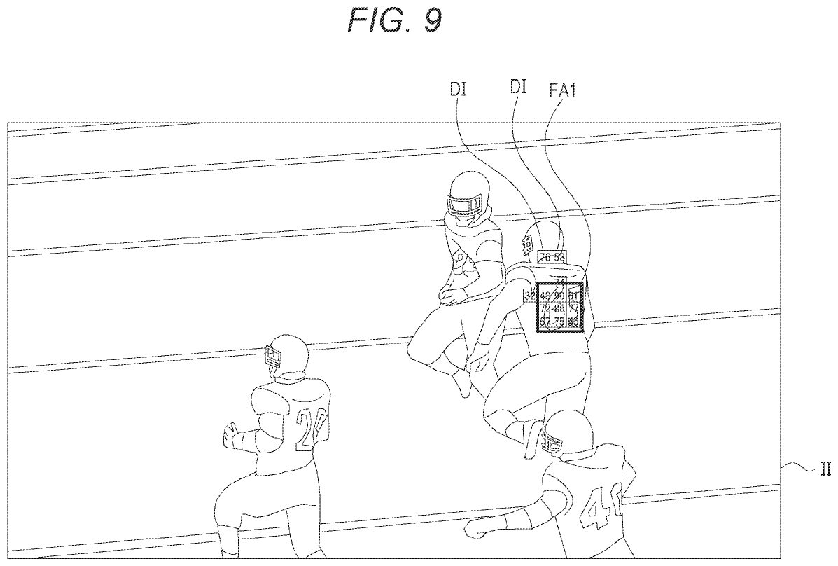

FIG. 9 illustrates a third example of the visualized contribution degree DoC. In this example, only the partial image region DI in which the contribution degree DoC is equal to or greater than a certain value is displayed with a frame, and the contribution degree DoC is displayed as a numerical value (0 to 100) in the frame of the partial image region DI.

In either method, the partial image region DI having a high contribution degree DoC is visualized for easy understanding.

An image in which the contribution degree DoC is visualized, that is, an image regarding the contribution degree DoC as illustrated in FIGS. 7 to 9 such as a heat map is presented to the user by the display control unit 5 in the subsequent stage.

The gaze region specification processing unit 3 performs a process of analyzing the contribution degree DoC and specifying the gaze region GA as a pre-stage process for performing the classification processing by the classification unit 4 in the subsequent stage.

In the analysis processing of the contribution degree DoC, for example, the partial image region DI having a high contribution degree DoC is specified as the gaze region GA. Note that, in a case where a cluster of partial image regions DI with a high contribution degree DoC exists, that region is specified as one gaze region GA.

Various methods can be considered as a method of specifying the gaze region GA from the heat map of the contribution degree DoC.

For example, when one partial image region DI is defined as one cell, after the contribution degree DoC is smoothed by the maximum value filter including three cells in each of the vertical and horizontal directions, the contribution degree DoC of the partial image region DI whose value does not change before and after the smoothing is not changed, and the contribution degree DoC of the other partial image regions DI is set to 0.

Furthermore, a small peak is eliminated by changing the contribution degree DoC less than the predetermined value to 0.

After the above processing, the partial image region DI having the contribution degree DoC other than zero remains. Each cluster of the remaining partial image regions DI is treated as one gaze region GA, and the partial image region DI is treated as a representative region RP of the gaze region GA.

Furthermore, one gaze region GA can include a peripheral partial image region DI around the representative region RP. For example, a region in which the contribution degree DoC before processing is a predetermined value or more in the partial image region DI around the representative region RP is included in one gaze region GA centered on the representative region RP.

That is, one gaze region GA may include a plurality of partial image regions DI.

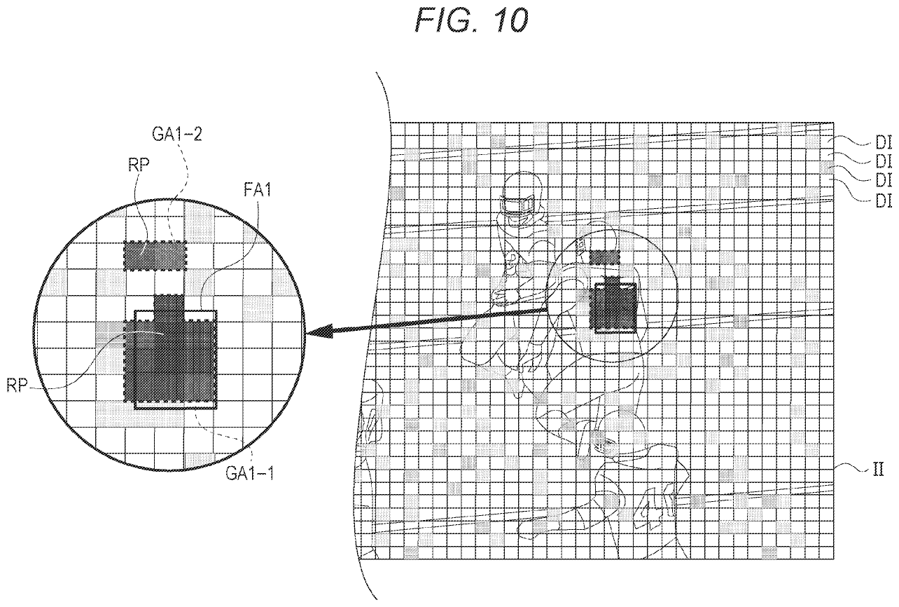

FIG. 10 illustrates a state in which gaze regions GA1-1 and GA1-2 are specified as gaze regions GA corresponding to prediction region FA1 in the input image II. In addition, a representative region RP is set for each of the gaze regions GA1-1 and GA1-2.

As another method of specifying the gaze region GA, for example, first, a region having a larger contribution degree DoC than the adjacent partial image region DI is extracted.

Next, the partial image region DI having the contribution degree DoC lower than the threshold is excluded.

Finally, the partial image regions DI with a short distance among the remaining partial image regions DI are collectively treated as one gaze region GA.

The representative region (or representative point) of the gaze region GA is a centroid point of the partial image region DI included in the gaze region GA. Note that, at this time, the center of gravity may be obtained using each contribution degree DoC as a weight.

The gaze region specification processing unit 3 analyzes the gaze region GA specified using various methods in this manner.

Specifically, the number of gaze regions GA, the position of the gaze region GA with respect to the prediction region FA, the difference between the contribution degree DoC of the prediction region FA and the contribution degree DoC outside the prediction region FA, and the like are considered.

In the example illustrated in FIG. 10, the number of gaze regions GA is “2”, and the gaze region GA1-1 is located within the prediction region FA and the gaze region GA1-2 is located outside the prediction region FA. In addition, in order to calculate a difference between the contribution degree DoC of the prediction region FA and the contribution degree DoC outside the prediction region FA, an average value of the contribution degree DoC of the prediction region FA and an average value of the contribution degree DoC outside the prediction region FA are calculated.

These pieces of information are used for classification processing in the classification unit 4 in the subsequent stage.

The classification unit 4 performs processing of evaluating and classifying validity of the gaze region GA with respect to the prediction region FA by using each piece of information obtained by the gaze region specification processing unit 3.

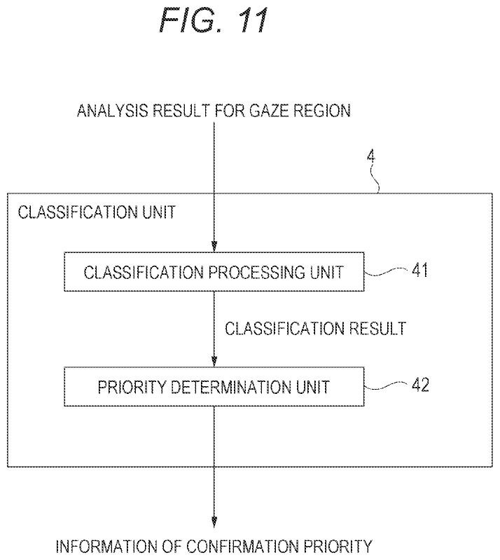

As illustrated in FIG. 11, the classification unit 4 includes a classification processing unit 41 and a priority determination unit 42.

The classification processing unit 41 evaluates the validity of the gaze region GA and classifies each data into categories on the basis of the result. Specifically, the classification processing unit 41 assigns a “valid” category, a “confirmation required” category, and a “utilized for analysis” category to the prediction result of the input image II.

The “valid” category is a category classified in a case where the recognition target RO has been detected on the basis of a correct basis, and is a category into which data having a low necessity to have the user confirm the validity of the gaze region GA is classified. That is, the case classified into the “valid” category is a case where the presentation priority to the user is the lowest.

The “confirmation required” category and the “utilized for analysis” category are categories classified in a case where they cannot be determined to be valid. That is, the category is classified into a case where there are both a case where the recognition target RO is detected on the basis of a correct basis and a case where the recognition target RO is detected on the basis of an incorrect basis, and there is a high necessity for the user to confirm the case.

The “confirmation required” category is a category classified in a case where it cannot be determined whether the gaze region GA as the basis of prediction is valid, and is a category into which data whose validity needs to be confirmed by the user is classified.

The “utilized for analysis” category is a category classified in a case where the AI model cannot be predicted on the basis of high reliability, and is a category into which data for which it is desirable for the user to analyze the cause is classified.

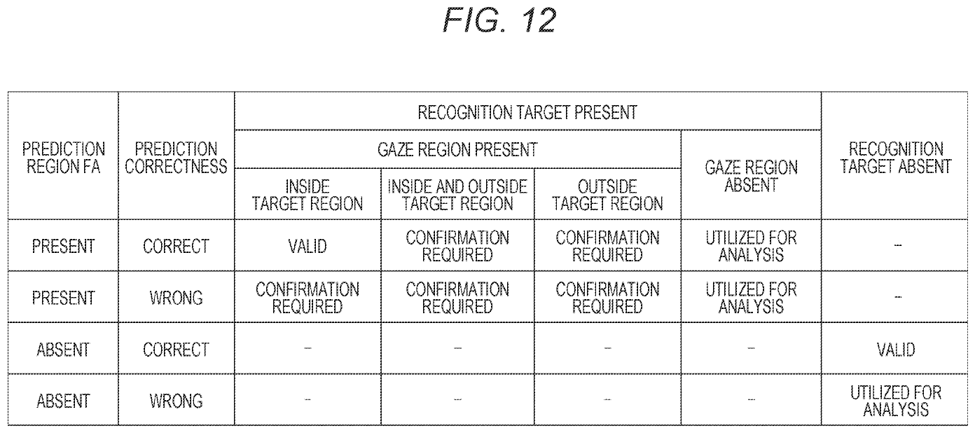

FIG. 12 illustrates an example of classification of the input image II based on the presence or absence of the prediction region FA, the position of the gaze region GA with respect to the prediction region FA, and whether the prediction result is correct or incorrect.

In a case where there is the prediction region FA, the positional relationship between the correctness of the prediction result and the gaze region GA with respect to the prediction region FA is important.

Specifically, a case where there is the prediction region FA will be described.

In a case where the prediction result is correct and the gaze region GA exists only in the prediction region FA, the gaze region GA is classified into the “valid” category as the validity evaluation of the gaze region GA.

In addition, in a case where the prediction result is correct and the gaze region GA exists both inside the prediction region FA and outside the prediction region FA (the case illustrated in FIG. 10), the gaze region GA is classified into the “confirmation required” category as the validity evaluation of the gaze region GA.

In addition, in a case where the prediction result is correct and the gaze region GA exists only outside the prediction region FA, the gaze region GA is classified into the “confirmation required” category as the validity evaluation of the gaze region GA.

In addition, in a case where the prediction result is wrong and the gaze region GA exists only inside the prediction region FA, the gaze region GA is classified into the “confirmation required” category as the validity evaluation of the gaze region GA.

In addition, in a case where the prediction result is wrong and the gaze region GA exists both inside the prediction region FA and outside the prediction region FA, the gaze region GA is classified into the “confirmation required” category as the validity evaluation of the gaze region GA.

In addition, in a case where the prediction result is wrong and the gaze region GA exists only outside the prediction region FA, the gaze region GA is classified into the “confirmation required” category as the validity evaluation of the gaze region GA.

In addition, in a case where the gaze region GA does not exist, the gaze region GA is classified into the “utilized for analysis” category.

“No recognition target” is a case where the recognition target RO has not been detected, which is inconsistent with the presence of the prediction region FA. Since there is no such data, classification into categories is not performed.

Next, a case where there is no prediction region FA will be described.

In a case where there is no prediction region FA, since the recognition target RO cannot be detected and the gaze region GA does not exist, classification into categories based on the relationship between the gaze region GA and the prediction region FA is not performed.

The case where the prediction result is correct and “no recognition target” is a case where the recognition target RO cannot be detected for the input image II in which the recognition target RO does not exist, and thus, is classified into the “valid” category.

The case where the prediction result is wrong and “no recognition target” is a case where it is determined that the recognition target RO does not exist although the recognition target RO exists in the input image II, and the case is classified into the “utilized for analysis” category.

The priority determination unit 42 gives a confirmation priority to each data of the input image II and its prediction result. The priority determination unit 42 gives a higher priority to data that needs to be confirmed by the user.

Specifically, the priority determination unit 42 sets the priority to the lowest for the data to which the “valid” category is assigned.

In addition, the priority determination unit 42 sets the data to which the “confirmation required” category is assigned with the highest priority (for example, first priority).

Further, the priority determination unit 42 sets the data to which the “utilized for analysis” category is assigned with the next highest priority (for example, the second priority) to the data to which the “confirmation required” category is assigned.

Here, as illustrated in FIG. 12, the data to which the “confirmation required” category is assigned includes various patterns. Therefore, it is conceivable to further change the priority among the data to which the “confirmation required” category is assigned.

Among the data to which the “confirmation required” category is assigned, which data is set with a high priority differs depending on the situation.

For example, in a case where it is intended to increase the correct answer rate of estimation by the AI model, the user is caused to preferentially confirm a case where the prediction result is wrong by setting a high priority.

On the other hand, in a case where the correct answer rate of AI is sufficient and it is desired to confirm the validity of the basis of prediction, a high priority is set to a case where the prediction result is correct and the gaze region GA exists outside the prediction region FA.

Note that the setting of the priority by the priority determination unit 42 may be a mode of giving a score such as 0 to 100, or may be a mode of giving flag information indicating whether or not confirmation by the user is required.

In addition, in a case where the flag information is assigned, “1” may be assigned only for a target that needs to be checked. That is, it is not necessary to perform the process of assigning “0” to an object that does not require confirmation.

Alternatively, a flag may be assigned only to those that do not require confirmation.

Furthermore, here, the example of classifying into the three categories of the “valid” category, the “confirmation required” category, and the “utilized for analysis” category has been described. However, the information may be classified into two categories of the “confirmation required” category and the “other” category, or may be classified into two categories of the “valid” category and the “other” category.

The display control unit 5 performs processing of causing the display unit to display the heat map for the contribution degree DoC, the validity of the gaze region GA, and the like so that the user can recognize the priority of confirmation.

Note that the display unit may be included in the information processing apparatus 1 or may be included in another information processing apparatus (for example, a user terminal used by the user) configured to be able to communicate with the information processing apparatus 1.

Some presentation screens to be presented to the user will be exemplified.

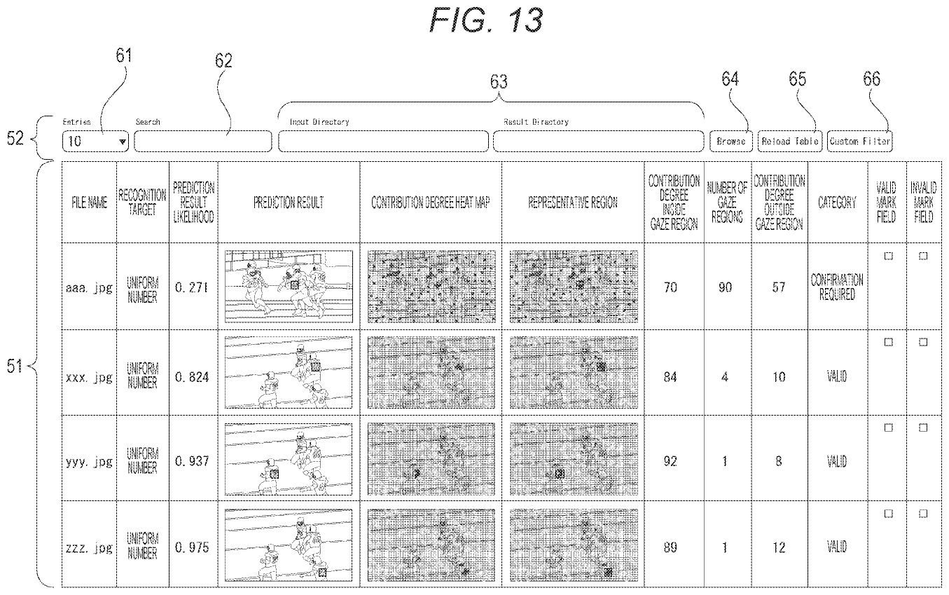

FIG. 13 illustrates a first example of the presentation screen. The presentation screen is provided with a data display unit 51 that displays various types of information such as images and data to be presented to the user, and a change operation unit 52 for changing a display mode of the data displayed on the data display unit 51.

The data display unit 51 displays the original image of the image recognition target on which one prediction region FA is superimposed, the heat map of the contribution degree DoC, and the gaze region.

Furthermore, in addition to these images, the data display unit 51 displays the file name of the original image, the recognition target RO, the prediction result likelihood PLF, the average value of the contribution degree DoC in the gaze region GA, the number of gaze regions GA, the average value of the contribution degree DoC outside the gaze region GA, the category, the valid mark field and the invalid mark field for inputting the confirmation result, and the like. In addition, whether the prediction result is correct or incorrect or the like may be displayed.

In the state illustrated in FIG. 13, the input image II and its data are displayed in descending order of presentation priority to the user.

The change operation unit 52 includes a number-of-data changing unit 61 that changes the number of data displayed on one page, a search field 62 for searching for data, a data address display field 63 for displaying and changing the places of input data and output data, a display button 64 for displaying data with settings designated by the user, a reload button 65, and a filter condition change button 66 for changing a filter condition.

By using the filter function, it is possible to display only data having a high presentation priority. It similarly applies to other presentation screens described later.

In addition, the data display unit 51 has a sorting function as a function of changing the display mode. For example, by selecting each item name in the table of the data display unit 51, the display order of the data display unit 51 is changed so as to be the display order according to the selected item.

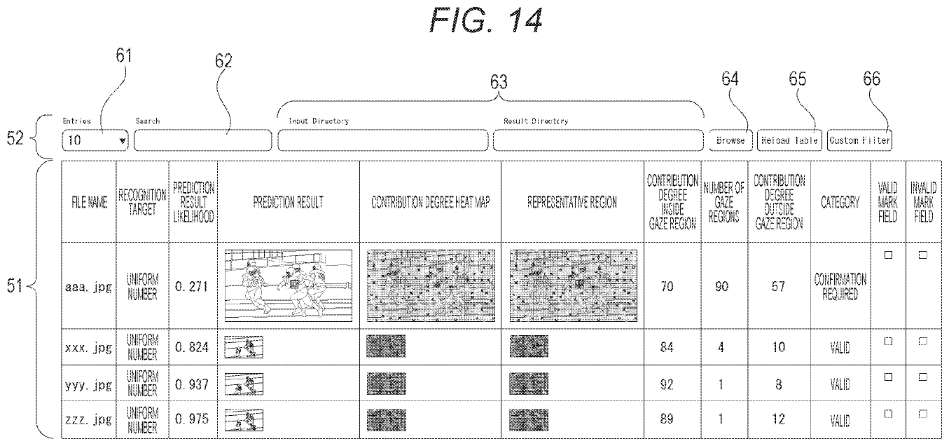

FIG. 14 illustrates a second example of the presentation screen. In the second example, information similar to that in the first example is presented. In addition, the size of each image is changed and displayed according to the classified category. Specifically, the image to which the “confirmation required” category is assigned is displayed large.

As a result, the user can easily recognize the data that needs to be checked.

Furthermore, in the state illustrated in FIG. 14, the input image II and its data are displayed in descending order of presentation priority to the user.

Note that, in addition to changing the size of the image, the data assigned with the “confirmation required” category may be emphasized by changing the color of the frame, or may be emphasized by changing the character color.

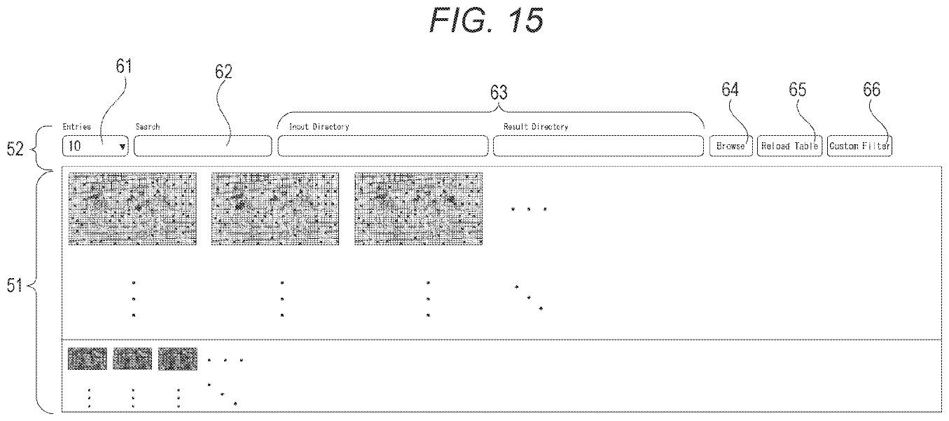

FIG. 15 illustrates a third example of the presentation screen. In the third example, only one image is displayed for one data. In the illustrated example, a heat map of the contribution degree DoC is displayed.

Note that, in a case where one image is selected from the plurality of images illustrated in FIG. 15, the file name of the original image, the recognition target RO, the prediction result likelihood PLF, the contribution degree DoC average value in the gaze region GA, the number of gaze regions GA, the contribution degree DoC average value outside the gaze region GA, the category, and the like may be displayed as details of data related to the selected image.

Note that, in the third example, as illustrated in the drawing, the size of the image is different for each data. For example, an image of data having a high priority of confirmation is displayed large, and an image of data having a low priority of confirmation is displayed small. Note that the display of the image of the data to which the “valid” category having the lowest priority of confirmation is assigned may be omitted.

Note that, in the state illustrated in FIG. 15, an image having a high presentation priority to the user is displayed at the top.

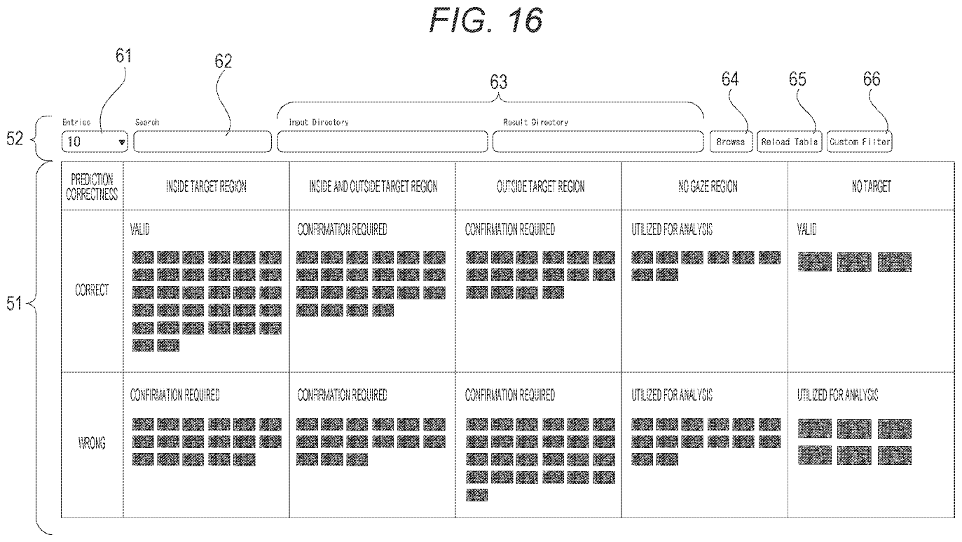

FIG. 16 illustrates a fourth example of the presentation screen. In the fourth example, each data is displayed for each classification result illustrated in FIG. 12.

For example, it is suitable in a case where it is desired to confirm data for each classification result as well as for each classified category. Furthermore, similarly to the third example, in a case where one image is selected, details of data for the image may be displayed.

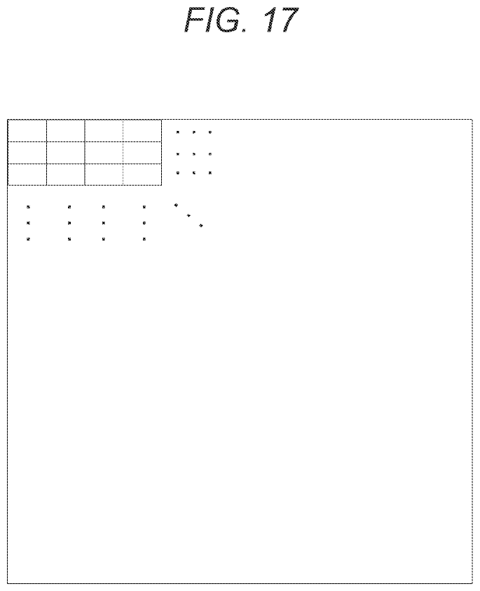

FIG. 17 illustrates a fifth example of the presentation screen. In the fifth example, only an image of each data is displayed in a matrix. Note that, in FIG. 17, only the outer frame of the image is illustrated, and the contents of the image (the input image II and the heat map of the contribution degree DoC superimposed thereon) are not illustrated in consideration of visibility of the drawing.

In this display mode, the user can confirm a large amount of data at a time.

Note that an image having a high confirmation priority may be displayed large, or only an image having a high presentation priority may be displayed.

Furthermore, similarly to the third example and the fourth example, in a case where one image is selected, details of data for the image may be displayed.

### 2. Computer Device

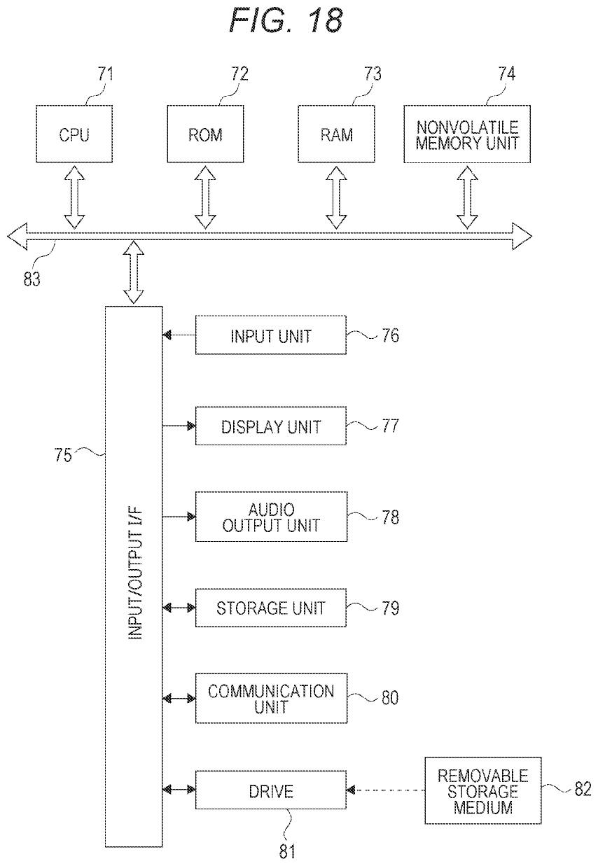

The information processing apparatus 1 and the user terminal used by the user described above have a configuration as a computer device. FIG. 18 illustrates a functional block diagram of the computer device.

Note that each computer device does not need to have all the configurations described below, and may have only a part thereof.

As illustrated in FIG. 18, a central processing unit (CPU) 71 of each computer device executes various processes in accordance with a program stored in a nonvolatile memory unit 74 such as a read only memory (ROM) 72 or, for example, an electrically erasable programmable read-only memory (EEP-ROM), or a program loaded from a storage unit 79 to a random access memory (RAM) 73. In addition, the RAM 73 appropriately stores data and the like necessary for the CPU 71 to execute various processes.

The CPU 71, the ROM 72, the RAM 73, and the nonvolatile memory unit 74 are connected to each other via a bus 83. An input/output interface 75 is also connected to the bus 83.

An input unit 76 including an operation element and an operation device is connected to the input/output interface 75.

For example, as the input unit 76, various types of operation elements and operation devices such as a keyboard, a mouse, a key, a dial, a touch panel, a touch pad, a remote controller, and the like are assumed.

A user operation is detected by the input unit 76, and a signal corresponding to the input operation is interpreted by the CPU 71.

In addition, a display unit 77 including a liquid crystal display (LCD), an organic EL panel, or the like, and an audio output unit 78 including a speaker or the like are integrally or separately connected to the input/output interface 75.

The display unit 77 is a display unit that performs various displays, and includes, for example, a separate display device or the like connected to a computer device.

The display unit 77 executes display of an image for various types of image processing, a moving image to be processed and the like on a display screen on the basis of an instruction of the CPU 71. Furthermore, the display unit 77 displays various types of operation menus, icons, messages and the like, that is, displays as a graphical user interface (GUI) on the basis of an instruction of the CPU 71.

There is a case where the storage unit 79 including a hard disk, a solid-state memory and the like, and a communication unit 80 including a modem and the like is connected to the input/output interface 75.

The communication unit 80 executes communication processing via a transmission path such as the Internet or performs wired/wireless communication with various types of devices, and communication using bus communication and the like.

A drive 81 is also connected to the input/output interface 75 as necessary, and a removable storage medium 82 such as a magnetic disk, an optical disk, a magneto-optical disk, or a semiconductor memory is appropriately mounted.

A data file such as an image file, various computer programs, and the like can be read from the removable storage medium 82 by the drive 81. The read data file is stored in the storage unit 79, and images and sounds included in the data file are output by the display unit 77 and the audio output unit 78. Furthermore, a computer program and the like read from the removable storage medium 82 are installed in the storage unit 79 as necessary.

In this computer device, for example, software for processing of the present embodiment can be installed via network communication by the communication unit 80 or the removable storage medium 82. Alternatively, the software may be stored in advance in the ROM 72, the storage unit 79, or the like.

The CPU 71 performs processing operation on the basis of various programs, so that necessary communication processing is executed in the information processing apparatus 1.

Note that the computer device constituting the information processing apparatus 1 is not limited to the single information processing apparatus as illustrated in FIG. 18, and may be configured by systematizing a plurality of information processing apparatuses. The plurality of information processing apparatuses may be systematized by a LAN or the like, or may be arranged in a remote place by a VPN or the like using the Internet or the like. The plurality of information processing apparatuses may include an information processing apparatus as a server group (cloud) usable by a cloud computing service.

### 3. Processing Flow

Processing executed by the information processing apparatus 1 in order to present, to the user, the evaluation result of the validity of the gaze region GA which is the pixel region on which the AI model has made the determination in the image recognition processing will be described with reference to the attached drawings.

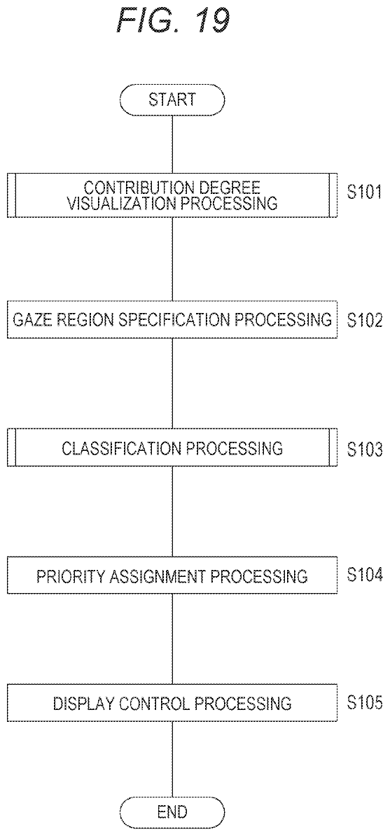

In step S101 of FIG. 19, the CPU 71 of the information processing apparatus 1 performs visualization processing of the contribution degree DoC. A detailed processing flow of this processing will be described later.

By the visualization processing of the contribution degree DoC, an image as illustrated in FIG. 7 or an image as illustrated in FIG. 8 is output. Note that, the frame representing the prediction region FA illustrated in each drawing may not be superimposed on the image.

That is, in the processing of step S101, an image in which the contribution degree DoC is visualized is generated so that the height of the contribution degree DoC for each partial image region DI can be recognized or the partial image region DI having a high contribution degree DoC can be recognized.

In step S102, the CPU 71 of the information processing apparatus 1 executes processing of specifying the gaze region GA. In this processing, as illustrated in FIG. 10, a region having a high contribution degree DoC is specified as the gaze region GA.

In step S103, the CPU 71 of the information processing apparatus 1 executes classification processing. By this processing, a label is assigned to the input image II according to the relationship between the prediction region FA and the gaze region GA or the like, and the input image II is classified into a category. The label is, for example, the “inside gaze region” label, the “outside gaze region” label, the “no gaze region” label, or the like illustrated in FIG. 12. A specific processing flow will be described later.

In step S104, the CPU 71 of the information processing apparatus 1 performs processing of assigning a priority to each data. The data classified into the category for each input image II is assigned a presentation priority according to the category.

On the basis of the presentation priority, the CPU 71 of the information processing apparatus 1 executes display control processing in step S105. With this processing, a presentation screen according to various display modes illustrated in FIGS. 13 to 17 is displayed on a display unit such as a monitor included in the information processing apparatus 1 or a display unit included in another information processing apparatus.

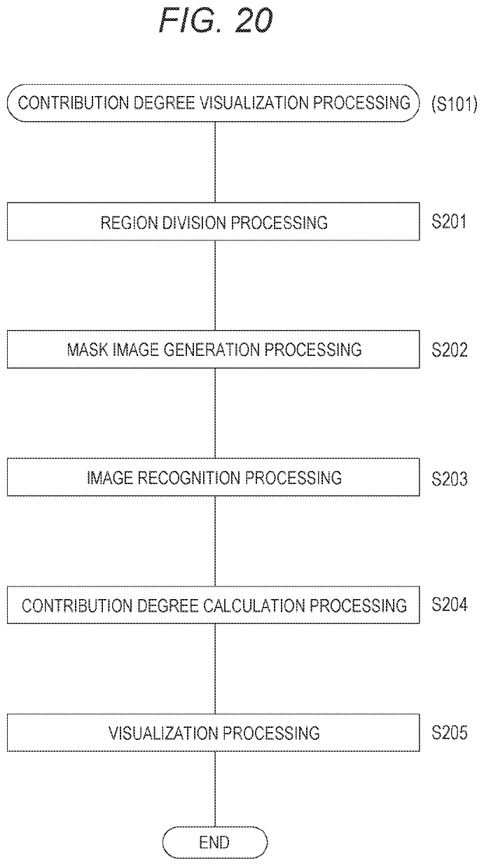

Details of the contribution degree visualization processing in step S101 are illustrated in FIG. 20.

In the contribution degree visualization processing, the CPU 71 of the information processing apparatus 1 performs region division processing in step S201. By this processing, the input image II is divided into partial image regions DI (see FIG. 5). Note that the partial image region DI may have a shape other than a rectangle by using a superpixel or the like.

In step S202, the CPU 71 of the information processing apparatus 1 executes processing of generating the mask image MI. FIG. 6 is an example of the mask image MI.

In step S203, the CPU 71 of the information processing apparatus 1 executes image recognition processing using the AI model. By this processing, image recognition processing for detecting the designated recognition target RO is executed.

In step S204, the CPU 71 of the information processing apparatus 1 executes processing of calculating the contribution degree DoC. In this processing, the contribution degree DoC is calculated for each partial image region DI.

In step S205, the CPU 71 of the information processing apparatus 1 performs a process of visualizing the contribution degree DoC. Various visualization methods are conceivable, and examples thereof are illustrated in FIGS. 7 to 9 in the above description.

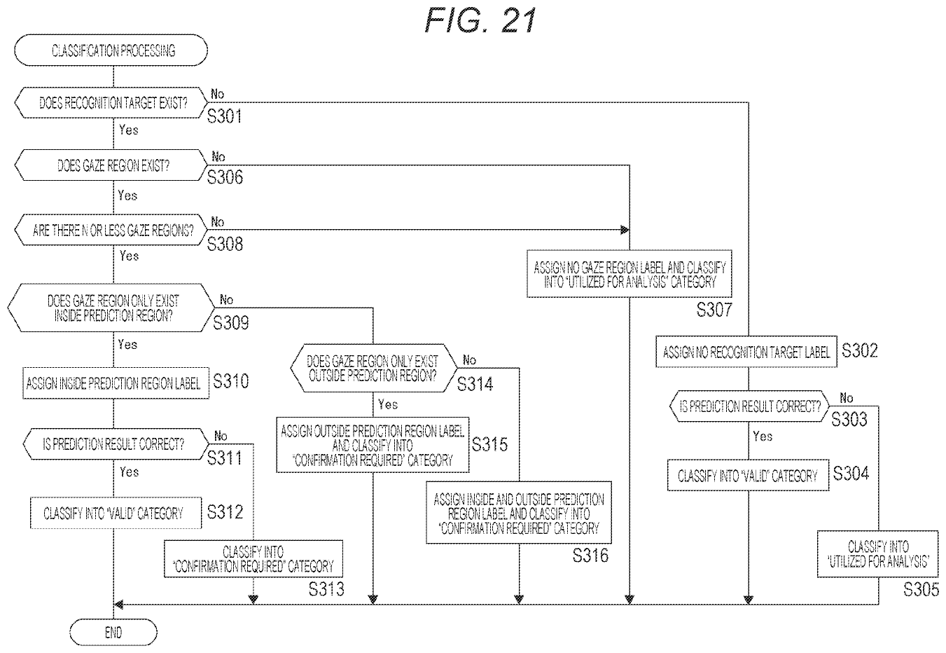

FIG. 21 illustrates an example of details of the classification processing in step S103 of FIG. 19.

Note that the classification processing is executed as many as the number of input images II.

In step S301, the CPU 71 of the information processing apparatus 1 determines whether or not the recognition target RO exists in the input image II.

In a case where it is determined that the recognition target RO does not exist, that is, in a case where the recognition target RO cannot be detected in the input image II, the CPU 71 of the information processing apparatus 1 assigns the “no recognition target” label to the input image II in step S302.

Subsequently, in step S303, the CPU 71 of the information processing apparatus 1 determines whether or not the prediction result that the recognition target RO has not been detected is correct. Whether or not the prediction result is correct may be determined and input by the user.

In a case where the prediction result is correct, the CPU 71 of the information processing apparatus 1 classifies the input image II into the “valid” category in step S304. This case corresponds to a case where the AI model has derived a correct conclusion on the basis of a correct basis.

On the other hand, in a case where it is determined in step S303 that the prediction result that the recognition target RO has not been able to be detected is not correct, that is, in a case where the recognition target RO has not been able to be detected even though the recognition target RO exists in the input image II, the CPU 71 of the information processing apparatus 1 classifies the input image II into the “utilized for analysis” category in step S305.

After executing either step S304 or step S305, the CPU 71 of the information processing apparatus 1 ends the classification processing illustrated in FIG. 21.

In a case where it is determined in step S301 that the recognition target RO exists in the input image II, the CPU 71 of the information processing apparatus 1 determines in step S306 whether or not the gaze region GA exists.

In a case where it is determined that there is no gaze region GA, that is, in a case where there is no partial image region DI having a large contribution degree DoC, the CPU 71 of the information processing apparatus 1 assigns a “no gaze region” label to the input image II and classifies the input image II into the “utilized for analysis” category in step S307.

The CPU 71 of the information processing apparatus 1 that has completed the processing in step S307 ends the classification processing illustrated in FIG. 21.

On the other hand, in a case where it is determined in step S306 that there is the gaze region GA, the CPU 71 of the information processing apparatus 1 determines in step S308 whether or not there are N or less gaze regions GA. For example, a numerical value less than 10 at most such as 4 or 5 is set as N.

In a case where the number of gaze regions GA is larger than N, the CPU 71 of the information processing apparatus 1 proceeds to the processing of step S307.

On the other hand, in a case where the number of gaze regions GA is N or less, the CPU 71 of the information processing apparatus 1 determines in step S309 whether or not the gaze region GA exists only in the prediction region FA.

In a case where the gaze region GA exists only in the prediction region FA, the CPU 71 of the information processing apparatus 1 assigns the “inside prediction region FA” label to the input image II in step S310.

Subsequently, in step S311, the CPU 71 of the information processing apparatus 1 determines whether or not the prediction result is correct.

In a case where the prediction result is correct, that is, in a case where the recognition target RO can be appropriately detected, the CPU 71 of the information processing apparatus 1 classifies the input image II into the “valid” category in step S312.

On the other hand, in a case where the prediction result is wrong, the CPU 71 of the information processing apparatus 1 classifies the input image II into the “confirmation required” category in step S313.

After finishing the processing of either step S312 or step S313, the CPU 71 of the information processing apparatus 1 finishes the classification processing illustrated in FIG. 21.

In step S309, in a case where the gaze region GA does not exist only inside the prediction region FA, that is, in a case where the gaze region GA exists at least outside the prediction region FA, the CPU 71 of the information processing apparatus 1 determines whether or not the gaze region GA exists only outside the prediction region FA in step S314.

In a case where it is determined that the gaze region GA exists only outside the prediction region FA, the CPU 71 of the information processing apparatus 1 assigns the “outside prediction region” label to the input image II and classifies the input image II into the “confirmation required” category in step S315.

On the other hand, in a case where it is determined that the gaze region GA does not exist only outside the prediction region FA, that is, in a case where it is determined that the gaze region GA exists both inside the prediction region FA and outside the prediction region FA, the CPU 71 of the information processing apparatus 1 assigns the label “inside and outside the prediction region” to the input image II and classifies the input image II into the “confirmation required” category in step S316.

After finishing the processing of either step S315 or step S316, the CPU 71 of the information processing apparatus 1 finishes the classification processing illustrated in FIG. 21.

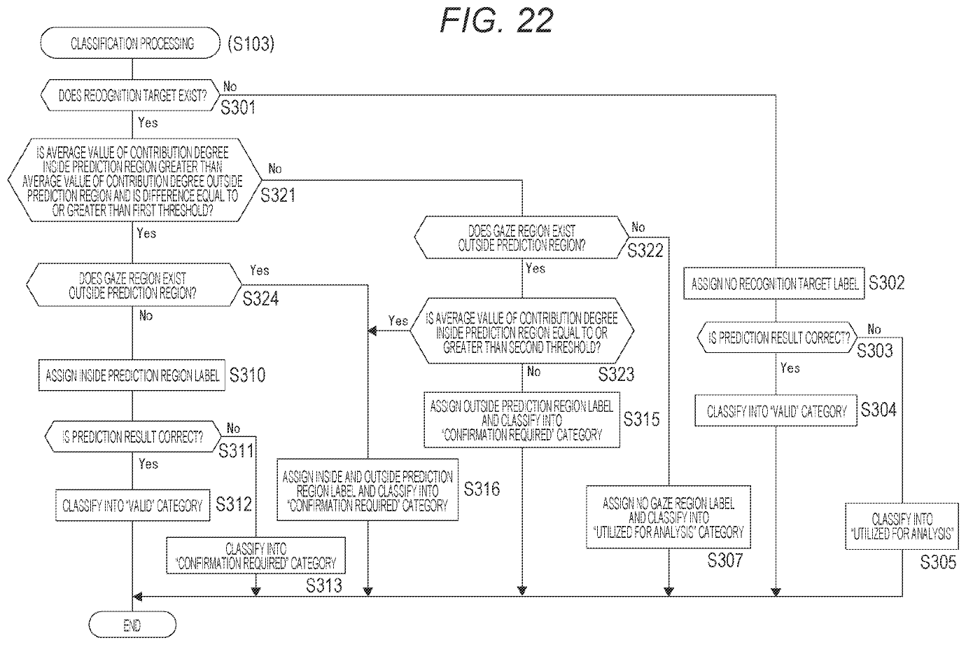

Another example of the classification processing in step S103 of FIG. 19 is illustrated in FIG. 22. Note that processes similar to those in FIG. 21 are denoted by the same step numbers, and description thereof is omitted as appropriate.

In step S301, the CPU 71 of the information processing apparatus 1 determines whether or not the recognition target RO exists in the input image II.

In a case where it is determined that the recognition target RO does not exist, the CPU 71 of the information processing apparatus 1 appropriately executes each process of steps S302 to S305 and terminates the series of processes illustrated in FIG. 22.

On the other hand, in a case where it is determined that there is the recognition target RO, in step S321, the CPU 71 of the information processing apparatus 1 determines whether or not the average value of the contribution degree DoC in the prediction region FA is larger than the average value of the contribution degree DoC outside the prediction region FA, and whether or not the difference is the first threshold Th1 or more.

In a case where it is determined that the average value of the contribution degree DoC in the prediction region FA is equal to or less than the average value of the contribution degree DoC outside the prediction region FA, or the difference is less than the first threshold Th1, for example, in a case where the average values of the contribution degrees DoC inside and outside the prediction region FA are similar, in a case where the contribution degree DoC outside the prediction region FA is higher, or in a case where the contribution degree DoC inside the prediction region FA is slightly higher, the CPU 71 of the information processing apparatus 1 determines in step S322 whether or not the gaze region GA exists outside the prediction region FA.

In a case where it is determined that the gaze region GA does not exist outside the prediction region FA, the gaze region GA does not exist also in the prediction region FA. Therefore, in step S307, the CPU 71 of the information processing apparatus 1 assigns a “no gaze region” label to the input image II and classifies the input image II into the “utilized for analysis” category.

On the other hand, in a case where it is determined that the gaze region GA exists outside the prediction region FA, the CPU 71 of the information processing apparatus 1 determines in step S323 whether or not the average value of the contribution degree DoC in the prediction region FA is equal to or greater than the second threshold Th2.

In a case where it is determined that the contribution degree DoC in the prediction region FA is equal to or greater than the second threshold Th2, the average value of the contribution degree DoC outside the prediction region FA is also equal to or greater than the second threshold Th2. Therefore, in step S316, the CPU 71 of the information processing apparatus 1 assigns the “inside and outside of prediction region” label to the input image II and classifies the input image II into the “confirmation required” category.

In a case where it is determined in step S323 that the contribution degree DoC in the prediction region FA is less than the second threshold Th2, since the gaze region GA does not exist in the prediction region FA, the CPU 71 of the information processing apparatus 1 assigns the “outside prediction region” label to the input image II and classifies the input image II into the “confirmation required” category in step S315.

After executing any of the processing of step S307, step S315, and step S316, the CPU 71 of the information processing apparatus 1 terminates the series of processes illustrated in FIG. 22.

In a case where it is determined in step S321 that the average value of the contribution degree DoC in the prediction region FA is larger than the average value of the contribution degree DoC outside the prediction region FA, and the difference is equal to or larger than the first threshold Th1, the CPU 71 of the information processing apparatus 1 determines in step S324 whether or not the gaze region GA exists outside the prediction region FA.

In a case where it is determined that the gaze region GA exists outside the prediction region FA, the CPU 71 of the information processing apparatus 1 assigns the label “inside and outside the prediction region” to the input image II and classifies the input image II into the “confirmation required” category in step S316.

On the other hand, in a case where it is determined in step S324 that the gaze region GA does not exist outside the prediction region FA, the CPU 71 of the information processing apparatus 1 executes each process of steps S310 to S313 and terminates the series of processes illustrated in FIG. 22.

By executing any of the classification processing illustrated in FIGS. 21 and 22, each input image II input to the AI model is labeled and classified into a category.

### 4. Application Example

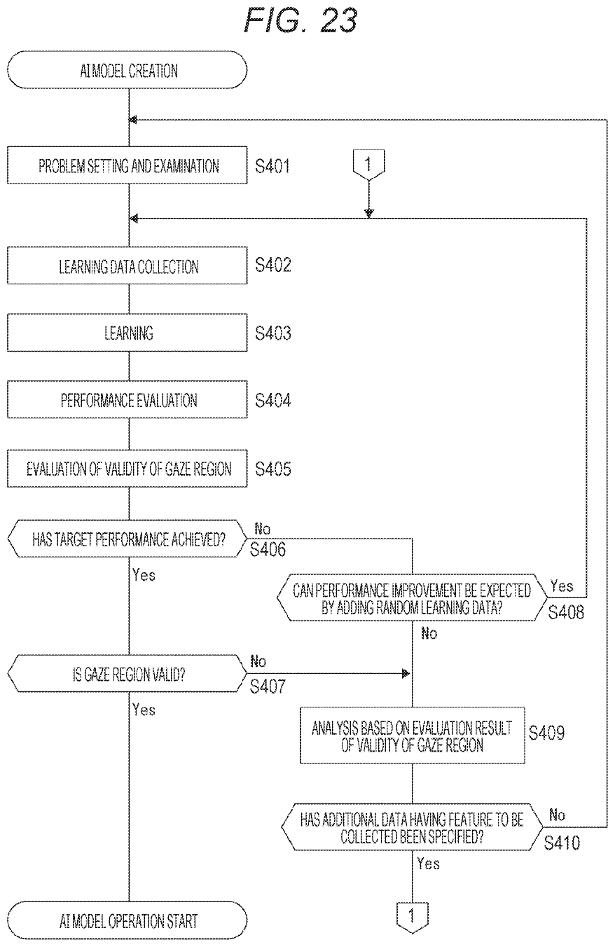

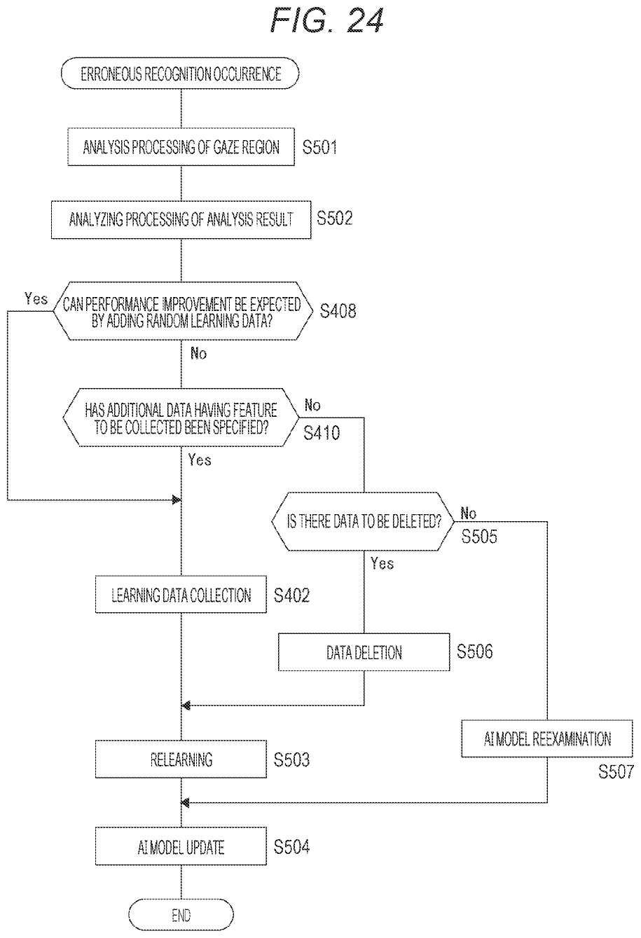

A processing flow for the user to achieve the purpose by using each of the above-described processes executed by the information processing apparatus 1 will be described with reference to FIGS. 23 and 24.

FIG. 23 illustrates an example of a processing flow in a case where the user uses the AI model generation function provided by the information processing apparatus 1 by connecting to the information processing apparatus 1 as the server device using the user terminal.

Note that, in the following description, each processing illustrated in FIGS. 23 and 24 is described as being executed in the information processing apparatus 1, but some processing may be executed in the user terminal.

In step S401, the CPU 71 of the information processing apparatus 1 sets and examines the problem. This process is, for example, a process of setting and considering a problem that the user wants to solve, such as traffic line analysis of a customer. Specifically, the CPU 71 of the information processing apparatus 1 performs initial setting for generating the AI model according to the purpose designated by the user, the specification information of the apparatus that operates the AI model, and the like. In the initial setting, for example, the number of layers, the number of nodes, and the like of the AI model are set.

In step S402, the CPU 71 of the information processing apparatus 1 collects learning data. The learning data is a plurality of pieces of image data, and may be designated by the user, or may be automatically acquired from an image database (DB) by the CPU 71 of the information processing apparatus 1 according to a purpose.

In step S403, the CPU 71 of the information processing apparatus 1 performs learning using the learning data. As a result, a learned AI model is acquired.

In step S404, the CPU 71 of the information processing apparatus 1 evaluates the performance of the learned AI model. For example, the performance evaluation is performed using a correct/incorrect rate or the like of the recognition result of the image recognition processing.

In step S405, the CPU 71 of the information processing apparatus 1 evaluates the validity of the gaze region. This process executes at least the processes of steps S101, S102, and S103 in FIG. 19. In addition, the processing of steps S104 and S105 of FIG. 19 may be executed as the processing for asking the user to confirm.

In step S406, the CPU 71 of the information processing apparatus 1 determines whether or not the target performance has been achieved. This determination processing may be executed by the CPU 71 of the information processing apparatus 1, or processing for causing the user to select whether or not the target performance has been achieved may be executed by the CPU 71 of the information processing apparatus 1 and the CPU 71 of the user terminal.

In a case where it is determined that the target performance is achieved, or in a case where the user selects that the target performance is achieved, the CPU 71 of the information processing apparatus 1 determines whether or not the gaze region GA is valid in step S407.

In a case where it is determined to be valid, the operation of the AI model is started. In starting the operation of the AI model, the CPU 71 of the information processing apparatus 1 may perform processing for starting the operation of the AI model. For example, processing of transmitting the AI model to the user terminal may be executed, or processing of storing the completed AI model in the DB may be executed.

In a case where it is determined in step S406 that the target performance has not been achieved, or in a case where the user selects that the target performance has not been achieved, the CPU 71 of the information processing apparatus 1 determines in step S408 whether or not performance improvement can be expected by adding random learning data.

For example, in a case where it is suspected that the learning iteration is insufficient, it is determined in step S408 that performance improvement can be expected by adding random learning data.

In this case, the CPU 71 of the information processing apparatus 1 returns to step S402 and collects the learning data.

On the other hand, in a case where it is determined that the performance improvement cannot be expected by adding the random learning data, the CPU 71 of the information processing apparatus 1 performs an analysis based on the evaluation result of the validity of the gaze region GA in step S409. That is, the analyzing processing based on the evaluation result of the validity in step S405 described above is performed.

Subsequently, in step S410, the CPU 71 of the information processing apparatus 1 determines whether or not additional data having a feature to be collected has been specified, that is, whether or not additional data to be collected has been specified. In a case where the additional data to be collected can be specified, the CPU 71 of the information processing apparatus 1 returns to step S402 and collects the learning data.

On the other hand, in a case where it is determined that the additional data to be collected cannot be specified, the CPU 71 of the information processing apparatus 1 returns to step S401 and starts again from the problem setting and examination.

The AI model thus obtained is operated by the user to achieve a desired purpose.

Then, a processing flow in a case where erroneous recognition occurs during operation is illustrated in FIG. 24. Note that processes similar to those in FIG. 23 are denoted by the same step numbers, and description thereof is omitted as appropriate.

In step S501, the CPU 71 of the information processing apparatus 1 performs analysis processing of the gaze region GA. As described above, this processing is the labeling of the recognition result focusing on the gaze region GA and the classification processing into categories.

In step S502, the CPU 71 of the information processing apparatus 1 analyzes the analysis result of the gaze region GA.

In step S408, the CPU 71 of the information processing apparatus 1 determines whether or not performance improvement can be expected by adding random learning data. In a case where it is determined that performance improvement can be expected by adding random learning data, the CPU 71 of the information processing apparatus 1 proceeds to the learning data collection processing in step S402.

Then, the CPU 71 of the information processing apparatus 1 performs relearning in step S503, and updates the AI model in step S504. The updated AI model is deployed and used in the user environment.

On the other hand, in a case where it is determined in step S408 that performance improvement cannot be expected by adding random learning data, the CPU 71 of the information processing apparatus 1 determines in step S410 whether or not there is additional data having a feature to be collected. Then, in a case where it is determined that there is additional data having a feature to be collected, the CPU 71 of the information processing apparatus 1 determines whether or not there is data to be deleted in step S505.

In a case where it is determined that there is data to be deleted, that is, in a case where there is an input image II that is not appropriate for learning of the AI model, the CPU 71 of the information processing apparatus 1 deletes the corresponding input image II in step S506, and then proceeds to the processing of step S503.

On the other hand, in a case where it is determined in step S505 that there is no data to be deleted, the CPU 71 of the information processing apparatus 1 reconsiders the AI model in step S507. In this processing, for example, each processing of steps S401, S402, and S403 in FIG. 23 is executed.

Subsequently, in step S504, the CPU 71 of the information processing apparatus 1 updates the AI model. By this processing, for example, the AI model newly acquired in step S507 is deployed in the user environment.

### 5. Summary

As described in each example above, the program executed by the information processing apparatus 1 as the arithmetic processing device includes the validity evaluation function (function of the classification processing unit 41) for evaluating the validity of the gaze region GA on the basis of the prediction region FA (FA1, FA2, FA3) that is an image region in which the recognition target RO is predicted to exist by the image recognition using the artificial intelligence (AI) with respect to the input image II and the gaze region GA (GA1, GA1-1, GA1-2) that is an image region that is the basis of the prediction.

For example, both determination of whether or not the gaze region GA is valid, determination of only validity of the gaze region GA, determination of only invalidity of the gaze region GA, and the like are performed.

Therefore, since the input image to be checked by the worker and the prediction result thereof can be specified in order to improve the performance of the artificial intelligence, the work can be efficiently performed, and the human cost and the time cost required for checking the basis on which the prediction result is derived can be reduced.

As described with reference to FIG. 21 and the like, in the evaluation of validity, it may be determined that the gaze region GA is valid.

As a result, it is possible to specify a case where the recognition target RO is predicted on the basis of the appropriate gaze region GA. In other words, it is possible to extract a case where the recognition target RO is predicted without being based on the appropriate gaze region GA or a case where it is unclear whether the gaze region GA is valid in the first place.

Therefore, it is possible to specify the input image to be confirmed by the worker and the prediction result thereof.

As described with reference to FIGS. 21, 22, and the like, in the validity evaluation function (function of the classification processing unit 41), evaluation may be performed on the basis of comparison between the prediction region FA and the gaze region GA.

For example, the validity is evaluated on the basis of a positional relationship between the prediction region FA and the gaze region GA, an overlapping state, and the like. As a result, it is possible to appropriately evaluate that the gaze region GA is valid, and thus, it is possible to appropriately specify the input image II to be confirmed by the worker and the prediction result thereof.

As described with reference to FIG. 21 and the like, the validity evaluation function (the function of the classification processing unit 41) may perform evaluation on the basis of the positional relationship between the prediction region FA and the gaze region GA.

As a result, for example, in a case where the prediction region FA and the gaze region GA coincide with each other or the like, the gaze region GA is determined to be valid. Therefore, the input image II that does not need to be confirmed by the worker and the prediction result thereof can be specified, and the work efficiency can be improved.

As described with reference to FIG. 21 and the like, in the validity evaluation function (function of the classification processing unit 41), the evaluation may be performed on the basis of whether or not the gaze region GA is located inside the prediction region FA.

Specifically, in a case where the gaze region GA is included in the prediction region FA, it can be evaluated that the detection of the recognition target RO is performed on the basis of the appropriate gaze region GA. That is, it is possible to evaluate that the gaze region GA is valid.

As described with reference to FIG. 21 and the like, the validity evaluation function (the function of the classification processing unit 41) may perform evaluation on the basis of the number of gaze regions GA.

For example, in a case where there is only one gaze region GA, there is a high possibility that the gaze region GA is valid. On the other hand, there is a case where the contribution degree DoC for the entire region of the input image II is large and the number of gaze regions GA increases. In such a case, there is a high possibility that the gaze region GA is not valid.

Therefore, by focusing on the number of gaze regions GA, it is possible to evaluate whether prediction (detection) of the recognition target RO is performed on the basis of an appropriate gaze region GA.

As described with reference to FIG. 21 and the like, in the validity evaluation function (function of the classification processing unit 41), in a case where the gaze region GA exists only inside the prediction region FA and the prediction of the recognition target RO is correct, it may be determined that the gaze region GA is valid.

In such prediction, there is an extremely high possibility that the recognition target RO can be correctly predicted on the basis of a correct basis. The efficiency of the confirmation work can be improved by evaluating the input image II and the prediction result as being valid.

As described with reference to FIG. 21 and the like, in a case where the gaze region GA cannot be determined to be valid in the validity evaluation function (function of the classification processing unit 41), the information processing apparatus 1 as an arithmetic processing device may be caused to execute the classification function (function of the classification unit 4) of classifying the prediction result of the image recognition according to whether or not the gaze region GA exists.

In a case where the gaze region GA does not exist, it cannot be determined whether the gaze region GA is valid in the first place. Since the prediction result likelihood PLF of such an input image II is also low, it is desirable that the worker analyze the cause. According to the present configuration, such an input image II can be classified into the “use for analysis” category, and the input image II used for analysis can be clarified.

As described with reference to FIGS. 11, 21, and the like, the information processing apparatus 1 as an arithmetic processing device may be caused to execute the priority determination function (the function of the priority determination unit 42) that determines the priority such that the priority of confirmation is higher in a case where the gaze region GA cannot be determined to be valid and the gaze region GA exists than in a case where the gaze region GA cannot be determined to be valid and the gaze region GA does not exist.

For example, the information processing apparatus 1 as the arithmetic processing device may be caused to execute a priority determination function (function of the priority determination unit 42) that determines the priority of confirmation for the prediction result of image recognition as the first priority in a case where the gaze region GA cannot be determined to be valid and the gaze region GA exists, and determines the priority of confirmation for the prediction result of image recognition as the second priority in a case where the gaze region GA cannot be determined to be valid and the gaze region GA does not exist, and the first priority may be made higher than the second priority.

The input image II having the first priority includes a case where the recognition target RO is erroneously recognized on the basis of the gaze region GA in the prediction region FA or the like. Such a case corresponds to a case where the AI model detects an erroneous target as the recognition target RO with confidence.

Such an input image II is useful for reducing the possibility of erroneous detection and improving the performance of the AI model by being used for relearning or additional learning of machine learning. Therefore, by setting the priority of such an input image II to be higher than the second priority as the first priority, efficient learning of the AI model can be performed.

As described with reference to FIGS. 19, 20, and the like, the information processing apparatus 1 as an arithmetic processing device may be caused to execute the contribution degree calculation function (the function of the contribution degree calculation unit 24) of calculating the contribution degree DoC to the prediction result by the image recognition for each partial image region DI in the input image II, and the gaze region specification function (the function of the gaze region specification processing unit 3) of specifying the gaze region GA on the basis of the contribution degree DoC.

By calculating the contribution degree DoC for each predetermined image region, it is possible to specify the gaze region GA.

As described with reference to FIG. 22 and the like, the validity evaluation function (the function of the classification processing unit 41) may perform evaluation on the basis of the difference between the contribution degree DoC to the prediction region FA and the contribution degree DoC to a region other than the prediction region FA.

For example, even in a case where the contribution degree DoC to the prediction region FA is high and it is determined that the gaze region GA exists in the prediction region FA, the contribution degree DoC to regions other than the prediction region FA may also be generally high.

In such a case, since the recognition target RO is detected in consideration of many regions other than the prediction region FA, it is not necessarily an appropriate state.

According to the present configuration, the validity is evaluated on the basis of the difference between the contribution degree DoC of the prediction region FA and the contribution degree DoC of the other region, so that it is possible to prevent the validity from being erroneously evaluated high.

As described with reference to FIGS. 4, 6, 20, and the like, in the contribution degree calculation function (function of the contribution degree calculation unit 24), the contribution degree DoC may be calculated on the basis of the prediction result likelihood PLF for the prediction region FA obtained as a result of performing prediction for a plurality of mask images MI in which the pattern of the presence or absence of the mask is different in units of partial image regions DI in the input image II.

That is, the contribution degree DoC is an index indicating how much the partial image region contributes to the derivation of the prediction result, in other words, the detection of the recognition target RO. By calculating the contribution degree DoC for each partial image region DI, the gaze region GA can be appropriately specified.

As described with reference to FIG. 5 and the like, the partial image region DI may be a pixel region divided in a lattice shape.

As a method of dividing the input image II into the partial image regions DI, for example, it is conceivable to use a superpixel in which similar pixels are collectively regarded as one region. However, in the superpixel, the partial image region DI becomes a large region, and sufficient resolution may not be obtained.

On the other hand, by determining the partial image region DI by dividing the partial image region DI into a lattice shape without considering the similarity for each pixel, it is possible to obtain sufficient resolution for the calculation of the contribution degree DoC.

As described with reference to FIG. 1 and the like, the display control function (the function of the display control unit 5) for executing the display control for presenting the prediction result of the image recognition may be executed by the information processing apparatus 1 as an arithmetic processing device.

By displaying the input image II or the like that requires confirmation by the worker, the work efficiency of the worker can be enhanced. In addition, by displaying information such as the prediction region FA, the gaze region GA, and whether the prediction result is correct or incorrect together with the input image II, it is possible to provide an environment in which the worker can easily perform the confirmation work.

As described with reference to each of FIGS. 13 to 17, in the display control function (function of the display control unit 5), the display control may be executed such that an image in which the prediction region FA and the gaze region GA are superimposed on the input image II is displayed.

As a result, it is easy to grasp the positions of the prediction region FA and the gaze region GA with respect to the input image II. Therefore, the work efficiency of the worker can be improved.

As described with reference to each of FIGS. 13 to 17, the information processing apparatus 1 as an arithmetic processing device may be caused to execute the priority determination function (function of the priority determination unit 42) for determining the priority of confirmation for the prediction result of image recognition, and the display control function (function of the display control unit 5) may be caused to execute display control so that display based on the priority is performed in presentation of the prediction result of image recognition.

For example, display control is performed such that the input image II, the prediction result, and the like are displayed in descending order of priority, display control is performed such that only the input image II with high priority and the prediction result are displayed, or display control is performed such that the input image II with high priority and the prediction result are displayed conspicuously. As a result, the efficiency of the confirmation work can be improved.

As described with reference to each of FIGS. 13 to 15, in the display control function (function of the display control unit 5), the display control may be executed such that the display is performed in the display order based on the priority.

As a result, the worker can easily grasp the input image II with high priority and the prediction result.

As described with reference to each of FIGS. 13 to 17, the display control function (function of the display control unit 5) may execute the display control such that the prediction result of the image recognition with low priority is not displayed.

As a result, since the input image II and the prediction result that do not need to be confirmed are not presented to the worker, work efficiency can be improved.

Such a program is a program to be executed by the information processing apparatus 1 described above, and can be recorded in advance in a hard disk drive (HDD) as a storage medium built in a device such as a computer device, a ROM in a microcomputer having a CPU, or the like. Alternatively, the program can be temporarily or permanently stored (recorded) in a removable storage medium such as a flexible disk, a compact disk read only memory (CD-ROM), a magneto optical (MO) disk, a digital versatile disc (DVD), a Blu-ray Disc (registered trademark), a magnetic disk, a semiconductor memory, or a memory card. Such a removable storage medium can be provided as what is called package software.

Furthermore, such a program can be installed from the removable storage medium into a personal computer or the like, or can be downloaded from a download site via a network such as a local area network (LAN) or the Internet.

The information processing apparatus 1 described above includes a validity evaluation unit (classification processing unit 41) that evaluates validity of the gaze region GA on the basis of the prediction region FA that is an image region in which the recognition target RO is predicted to exist by the image recognition using the artificial intelligence AI with respect to the input image II and the gaze region GA that is an image region that is the basis of the prediction.

In the information processing method executed by the information processing apparatus 1, the arithmetic processing device executes validity evaluation processing (processing by the classification processing unit 41) for evaluating validity of the gaze region GA on the basis of the prediction region FA that is an image region in which the recognition target RO is predicted to exist by the image recognition using the artificial intelligence AI with respect to the input image II and the gaze region GA that is an image region that is the basis of the prediction.

Note that, the effects described in the present specification are merely examples and are not limited, and other effects may be provided.

Furthermore, the above-described respective examples may be combined in any way, and the above-described various functions and effects may be obtained even in a case where various combinations are used.

### 6. Present Technology

Note that the present technology can also adopt the following configurations.
(1)

A program
causing an arithmetic processing device to execute a validity evaluation function of evaluating validity of a gaze region on the basis of a prediction region that is an image region in which a recognition target is predicted to exist by image recognition using artificial intelligence on an input image and the gaze region that is an image region that is a basis of prediction.
(2)

The program according to (1),
in which evaluation of the validity determines that the gaze region is valid.
(3)

The program according to any one of (1) to (2),
in which the validity evaluation function performs evaluation on the basis of comparison between the prediction region and the gaze region.
(4)

The program according to (3),
in which the validity evaluation function performs the evaluation on the basis of a positional relationship between the prediction region and the gaze region.
(5)

The program according to (4),
in which the validity evaluation function performs the evaluation on the basis of whether or not the gaze region is positioned within the prediction region.
(6)

The program according to any one of (1) to (5),
in which the validity evaluation function performs evaluation on the basis of the number of gaze regions.
(7)

The program according to (2),
in which the validity evaluation function determines that the gaze region is valid in a case where the gaze region exists only in the prediction region and the prediction of the recognition target is correct.
(8)

The program according to (2),
further causing the arithmetic processing device to execute a classification function of classifying a prediction result of the image recognition according to whether or not the gaze region exists in a case where the gaze region cannot be determined to be valid in the validity evaluation function.
(9)

The program according to (8),
further causing the arithmetic processing device to execute a priority determination function of determining priority such that a priority of confirmation is higher in a case where the gaze region cannot be determined to be valid and the gaze region exists than in a case where the gaze region cannot be determined to be valid and the gaze region does not exist.
(10)

The program according to any one of (1) to (9), further causing the arithmetic processing device to execute:
a contribution degree calculation function of calculating a contribution degree to a prediction result by the image recognition for each partial image region in the input image; and
a gaze region specification function of specifying the gaze region on the basis of the contribution degree.
(11)

The program according to (10),
in which the validity evaluation function performs evaluation on the basis of a difference between the contribution degree for the prediction region and the contribution degree for a region other than the prediction region.
(12)

The program according to any one of (10) to (11),
in which the contribution degree calculation function calculates the contribution degree on the basis of a prediction result likelihood for the prediction region obtained as a result of performing the prediction on a plurality of mask images in which patterns of presence or absence of a mask are made different in units of the partial image region in the input image.
(13)

The program according to any one of (10) to (12),
in which the partial image region is a pixel region divided in a lattice shape.
(14)

The program according to any one of (1) to (13),
further causing the arithmetic processing device to execute a display control function for executing display control for presenting a prediction result of the image recognition.
(15)

The program according to (14),
in which the display control function performs the display control such that an image in which the prediction region and the gaze region are superimposed on an input image is displayed.
(16)

The program according to any one of (14) to (15),
further causing the arithmetic processing device to execute a priority determination function of determining a priority of confirmation for a prediction result of the image recognition,
in which the display control function causes the display control to be executed such that display based on the priority is performed in presentation of the prediction result of the image recognition.
(17)

The program according to (16),
in which the display control function executes the display control such that display is performed in a display order based on the priority.
(18)

The program according to any one of (16) to (17),
in which the display control function executes the display control such that the prediction result of the image recognition with the low priority is not displayed.
(19)

An information processing apparatus including
a validity evaluation unit that evaluates validity of a gaze region on the basis of a prediction region that is an image region in which a recognition target is predicted to exist by image recognition using artificial intelligence on an input image and the gaze region that is an image region that is a basis of prediction.
(20)

An information processing method in which
an arithmetic processing device executes validity evaluation processing of evaluating validity of a gaze region on the basis of a prediction region that is an image region in which a recognition target is predicted to exist by image recognition using artificial intelligence on an input image and the gaze region that is an image region that is a basis of prediction.

### REFERENCE SIGNS LIST

1 Information processing apparatus
3 Gaze region specification processing unit (gaze region specification function)
4 Classification unit (classification function)
5 Display control unit (display control function)
24 Contribution degree calculation unit (contribution degree calculation function)
41 Classification processing unit (validity evaluation function)
42 Priority determination unit (priority determination function)
II Input image
RO Recognition target
FA, FA1, FA2, FA3 Prediction region
GA, GA1, GA1-1, GA1-2 Gaze region
DI, DIM Partial image region
MI Mask image
PLF Prediction result likelihood
DoC Contribution degree

1. A program
causing an arithmetic processing device to execute a validity evaluation function of evaluating validity of a gaze region on a basis of a prediction region that is an image region in which a recognition target is predicted to exist by image recognition using artificial intelligence on an input image and the gaze region that is an image region that is a basis of prediction.

2. The program according to claim 1,
wherein evaluation of the validity determines that the gaze region is valid.

3. The program according to claim 1,
wherein the validity evaluation function performs evaluation on a basis of comparison between the prediction region and the gaze region.

4. The program according to claim 3,
wherein the validity evaluation function performs the evaluation on a basis of a positional relationship between the prediction region and the gaze region.

5. The program according to claim 4,
wherein the validity evaluation function performs the evaluation on a basis of whether or not the gaze region is positioned within the prediction region.

6. The program according to claim 1,
wherein the validity evaluation function performs the evaluation on a basis of the number of gaze regions.

7. The program according to claim 2,
wherein the validity evaluation function determines that the gaze region is valid in a case where the gaze region exists only in the prediction region and the prediction of the recognition target is correct.

8. The program according to claim 2,
further causing the arithmetic processing device to execute a classification function of classifying a prediction result of the image recognition according to whether or not the gaze region exists in a case where the gaze region cannot be determined to be valid in the validity evaluation function.

9. The program according to claim 8,
further causing the arithmetic processing device to execute a priority determination function of determining priority such that a priority of confirmation is higher in a case where the gaze region cannot be determined to be valid and the gaze region exists than in a case where the gaze region cannot be determined to be valid and the gaze region does not exist.

10. The program according to claim 1, further causing the arithmetic processing device to execute:
a contribution degree calculation function of calculating a contribution degree to a prediction result by the image recognition for each partial image region in the input image; and
a gaze region specification function of specifying the gaze region on a basis of the contribution degree.

11. The program according to claim 10,
wherein the validity evaluation function performs the evaluation on a basis of a difference between the contribution degree for the prediction region and the contribution degree for a region other than the prediction region.

12. The program according to claim 10,
wherein the contribution degree calculation function calculates the contribution degree on a basis of a prediction result likelihood for the prediction region obtained as a result of performing the prediction on a plurality of mask images in which patterns of presence or absence of a mask are made different in units of the partial image region in the input image.

13. The program according to claim 10,
wherein the partial image region is a pixel region divided in a lattice shape.

14. The program according to claim 1,
further causing the arithmetic processing device to execute a display control function for executing display control for presenting a prediction result of the image recognition.

15. The program according to claim 14,
wherein the display control function performs the display control such that an image in which the prediction region and the gaze region are superimposed on an input image is displayed.

16. The program according to claim 14,
further causing the arithmetic processing device to execute a priority determination function of determining a priority of confirmation for a prediction result of the image recognition,
wherein the display control function causes the display control to be executed such that display based on the priority is performed in presentation of the prediction result of the image recognition.

17. The program according to claim 16,
wherein the display control function executes the display control such that display is performed in a display order based on the priority.

18. The program according to claim 16,
wherein the display control function executes the display control such that the prediction result of the image recognition with the low priority is not displayed.

19. An information processing apparatus comprising
a validity evaluation unit that evaluates validity of a gaze region on a basis of a prediction region that is an image region in which a recognition target is predicted to exist by image recognition using artificial intelligence on an input image and the gaze region that is an image region that is a basis of prediction.

20. An information processing method in which
an arithmetic processing device executes validity evaluation processing of evaluating validity of a gaze region on a basis of a prediction region that is an image region in which a recognition target is predicted to exist by image recognition using artificial intelligence on an input image and the gaze region that is an image region that is a basis of prediction.
